(19) United States
(12) Patent Application Publication
(10) Pub. No.: US 2015/0191073 A1
(43) Pub. Date: Jul. 9, 2015

(54) METHOD AND VEHICLE FOR OPERATING A VEHICLE AIR CONDITIONING SYSTEM

(71) Applicants: Ulf Björkerud, Vastra Frolunda (SE); Hans Westerlind, Nol (SE)

(72) Inventors: Ulf Björkerud, Vastra Frolunda (SE); Hans Westerlind, Nol (SE)

(73) Assignee: VOLVO TRUCK CORPORATION, Göteborg (SE)

(21) Appl. No.: 14/418,102

(22) PCT Filed: Aug. 30, 2012
(86) PCT No.: PCT/SE2012/000126

§ 371 Date: Jan. 29, 2015

(51) Int. Cl. B60H 1/00

(52) U.S. Cl. CPC B60H 1/00778; B60H 1/00007

(57) ABSTRACT

In a method and a vehicle for operating a vehicle heating, ventilating and cooling air conditioning system, the vehicle has an engine, to provide engine on and engine off operation, and a control unit for timer controlled activation and temperature control of the air conditioning system when the engine is off. The control unit allows an operator to set a target time and a target temperature related to the target time. The method includes the step of ventilating an interior compartment of the vehicle to ambient air for a period of time before the set target time, if the target temperature is lower than the interior temperature and the ambient air temperature is lower than the interior temperature.

### BACKGROUND AND SUMMARY

The present invention relates to a method and a vehicle for operating a vehicle heating, ventilating and cooling air conditioning system, the vehicle having an engine, to provide engine on and engine of operation, and a control unit for timer controlled activation and temperature control of the air conditioning system when the engine is off.

The driver's cab of a commercial long haul transport vehicle includes a sleeping compartment for resting. Driver comfort is essential for effective driver recovery for maintaining traffic safety. Thus, the cab of a modern commercial long haul vehicle includes many features to minimize the stress and fatigue placed on the driver during the operation of the vehicle. These features include a heating, ventilation and air conditioning (HVAC) system that provide a comfortable environment for the driver.

A common solution to provide air conditioning when the vehicle is parked is to add a separate AC-system which is powered by vehicle batteries or by shore power. This solution is rather expensive in view of the limited added functionality.

U.S. Pat. No. 4,934,158 describes a vehicle air conditioning system which can operate with engine on or with engine off. This allows for operating the single air conditioning system without running the vehicle's engine.

In order to run an air conditioning system when the engine is turned off an electrically driven AC-compressor is installed in parallel with the standard mounted, engine-driven, mechanical AC-compressor. When the engine is turned off, the electrically driven compressor can be supplied with electricity by cable (shore power).

Unfortunately, shore power is not often available for commercial long haul vehicles. An obvious alternative would be to power the electrically driven AC-compressor by electricity stored in vehicle on-board batteries.

A problem when using this type of HVAC system on energy stored in the vehicle batteries is that energy consumption is rather high, e.g. in the range of several hundred Watts for a considerable period, when cooling the interior temperature of a vehicle parked in sunlight to a comfortable level. Vehicle on-board batteries are heavy and expensive, thus energy stored in batteries is limited and need to be prioritized for engine start up. Also, recharging of batteries via the vehicle generator charging, system increases fuel consumption.

Thus there is a need for an energy saving method of operating an HVAC system in a vehicle during engine off conditions.

It is desirable to provide an energy saving method of operating a vehicle heating, ventilating and cooling air conditioning system, the vehicle having an engine to provide engine on or engine off operation, and a control unit for timer controlled, activation and temperature control of the air conditioning system when the engine is off, wherein the control unit allows an operator to set a target time and a target temperature related to said target time.

According to an aspect of the invention, the above is at least partly met by a method of operating a vehicle heating, ventilating and cooling air conditioning system, the vehicle having an engine, to provide engine on and engine off operation, and a control unit for timer controlled activation and temperature control of the air conditioning system when the engine is off, wherein the control unit allows an operator to set a target time and a target temperature related to said target time, the method comprising ventilating an interior compartment of the vehicle to ambient air for a period of time before the set target time, if the target temperature is lower than the interior temperature and the ambient air temperature is lower than the interior temperature.

The invention, according to an aspect thereof, is based on the understanding that the temperature of the ambient air is usually lower than the temperature of the interior compartment of a vehicle, allowing ambient air to be used for ventilation of the interior compartment before activation of an energy consuming cooling function of a HVAC system. Thus, energy can be saved without compromising functionality.

According to an embodiment of the invention, said ambient air ventilating period can be ended when the interior temperature is close to the ambient air temperature.

Preferably, the air conditioning system cooling function is activated, for a period of time only if the ventilating period has ended before the target time and the interior temperature is above the target temperature. The air conditioning cooling function can be deactivated when the interior temperature is close to the target temperature.

Another aspect of the method according to the invention involves the step of allowing the control unit to automatically select a mode of operation for the HVAC system to minimize energy consumption. The control unit timer controlled operation of the HVAC system enables the use of software that can select at optimal mode of operation in view of the ambient temperature to minimize energy consumption.

According, to a further embodiment of the invention, the air conditioning system cooling function is only operated until stored vehicle electric power capacity is consumed down to a certain level.

A vehicle with a heating, ventilating and cooling air conditioning system adapted for performing the invention is provided with a control unit for timer controlled activation and temperature control of the air conditioning system when the engine is off, wherein the control unit communicates with a sensor for interior compartment temperature and a sensor for ambient air temperature. A vehicle according to the invention with a HVAC system integrated with a control unit with sensors and timer controlled activation when the engine is off, can be provided with more functionality than a vehicle with a common HVAC system for engine on and a separate AC system for engine off. Preferably, the control unit communicates with a capacity sensor for stored vehicle electric power.

According to still another aspect of the invention, the control unit is provided with software for automatic control of battery state of charge and for regulating interior ventilation, cooling output and fan speed to reach a requested temperature with a minimum of electric energy waste. The integrated solution with a HVAC control unit communicating with a power communicating management system allows control unit software to regulate ventilation, cooling output and fan speed to achieve a desired level of comfort in a vehicle, with a minimum of energy waste. Preferably, the control unit timer is also integrated into the HVAC system.

According to a further embodiment of the invention, an electrically driven condenser cooling fan of the HVAC system is adapted to supply cooling air to support an engine cooling fan when the vehicle engine is running. The air flow produced by a big, power consuming engine cooling fan may not always be needed, in these conditions, the electrically driven condenser cooling, fan can be used for creating the needed air flow for engine cooling.

Preferably, the control unit is adapted to open an ambient air inlet regularly in order to avoid carbon dioxide build-up in the vehicle interior.

### BRIEF DESCRIPTION OF DRAWINGS

The invention will be described in greater detail in the following, with reference to the attached drawings, in which

FIG. 1 is a schematic view of a HVAC system adapted to utilize the method according to the invention, and

FIG. 2 is a schematic view of a truck cab with means for ventilating the truck cab interior to ambient air.

### DETAILED DESCRIPTION

The embodiments of the invention with further developments described in the following are to be regarded only as examples and are in no way to limit the scope of the protection provided by the claims. The arrangement is suitable for all kinds of vehicles and boats, but a truck is used to exemplify the arrangement.

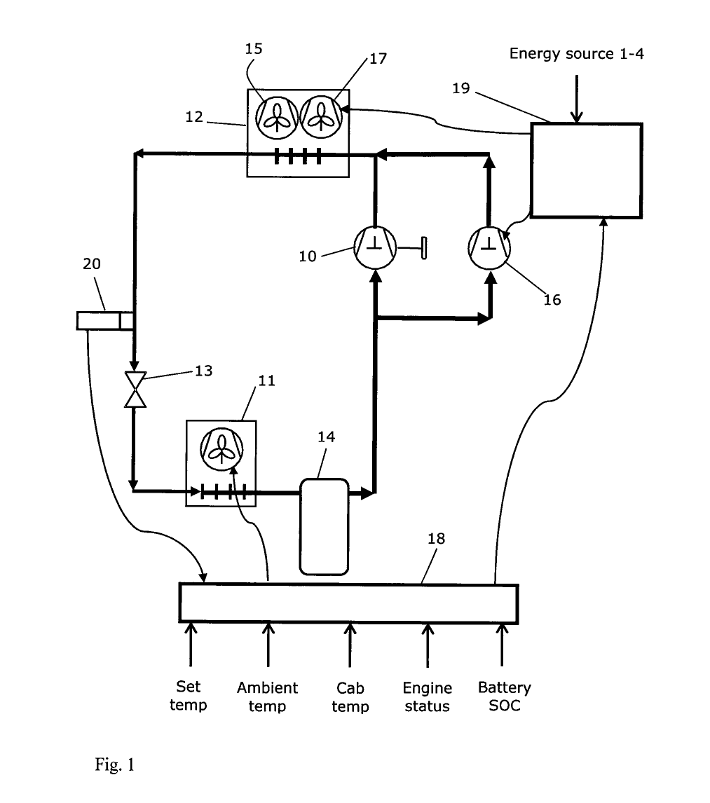

FIG. 1 shows the basic layout of a HVAC system adapted for use in a vehicle in accordance with the invention. A mechanical AC-compressor 10 is mounted on the vehicle's engine, and is driven, for example, by the engines belt transmission. The compressor 10 sucks gaseous refrigerant from an evaporator 11 positioned in the HVAC unit in the cab or passenger compartment of the vehicle, and pumps it in under high temperature and pressure to the condenser 12 where it condenses to liquid during heat transfer to the environment. The pressure is lowered through an expansion valve 13 before it enters the evaporator 11 and boils to gas during heat pick-up from the surrounding air which flows through the evaporator 11 by means of an electrically driven blower fan.

A bottle 14 is positioned either between the condenser 12 and the expansion valve 13 (Receiver/Dryer) or as shown m FIG. 1 between the evaporator 11 and the compressor 10 (accumulator) depending on the type of expansion valve. The components in the HVAC system are connected with each other through special pipes and hoses.

A flow of cooling air to the condenser 12 is normally supplied through the ram air pressure when driving with a certain speed, and through the vehicle's engine cooling fan 15 at lower or no speed. For trucks, this fan is normally driven by the engine and cannot be operated when the engine is turned off.

An electrically driven AC-compressor 16 is connected with pipes and hoses in parallel to the truck's mechanically driven AC-compressor 10. The compressor 16 can be of the same type as originally designed for passenger hybrid cars, or the same type as used for stationary cooling Of heat pump systems (hermetic compressors).

An electrically driven fan 17 is positioned in front of the vehicles standard condenser 12, to provide condenser cooling at engine off condition since the engine cooling fan 15 cannot function, if not electrically drive).

The electrically driven fan 17 can also be used for supplying a cooling air flow to the condenser 12 at normal AC operation (when the engine is operated) in order to avoid operation of the Engine cooling an 15, which normally requires more power to achieve the same airflow over the condenser 12.

At lower temperatures and engine power, they can also contribute to cool the engine Radiator and Charge Air Cooler, normally positioned downstream the condenser 12 in the cooling air flow.

Non-return valves, or check-valves, can be mourned in the refrigerant circuit, either behind both compressors 10, 16, or behind the electrically driven compressor 16, to avoid condensation of gaseous refrigerant to liquid that can accumulate in the inactive compressor.

The above schematically described HVAC system is controlled. by a climate control unit 18. The control unit 18 communicates with a pressure sensor 20 which enables the control unit to monitor pressure levels in the refrigerant circuit. The control unit 18 software receives input data via:
an operator input display for timer Set temperature,
an Ambient temperature sensor,
an interior/Cab temperature sensor,
an Engine status sensor, and
a Battery State Of Charge sensor.

An electric inverter unit 19 converts or inverts the electric power from a power source to relevant voltage for the electrically driven compressor 16. The inverter unit 19 also powers the condenser fan 17. The power source is controlled by the inverter unit 19, and power supply to the HVAC system during engine of mode can be prioritised in the following order:

1. shore power if available

2. Auxiliary Power Unit (APU) if available

3. extra batteries, if available. Can be high cycling performance type batteries.

4. the starter batteries.

Batteries mean all types of existing batteries for vehicles, such as lead acid (Pb). Nickel-metal hydride (NiMH) or Lithium-ion(Li ion)-battery.

If the system is driven by the vehicle starter batteries, it is important to secure that they are not overly discharged. To secure this, the cooling capacity can be limited for max operation time.

Preferably a Vehicle provided with the above described HVAC system is equipped with a battery power management system that can indicate when the battery State Of Charge (SOC) is low, so that the HVAC operation can he stopped. The driver can get a warning signal before the operation is stopped.

If the HVAC system is driven by shore power, an auxiliary power unit or extra batteries, the cooling power can be unlimited, or limited according to the hardware or fuse limitations with no need for restricting due to starter battery SOC.

The inverter unit 19 is the interface between the climate control unit 18 and the electrically driven AC compressor 16, condenser fan 17 and the not shown poser source.

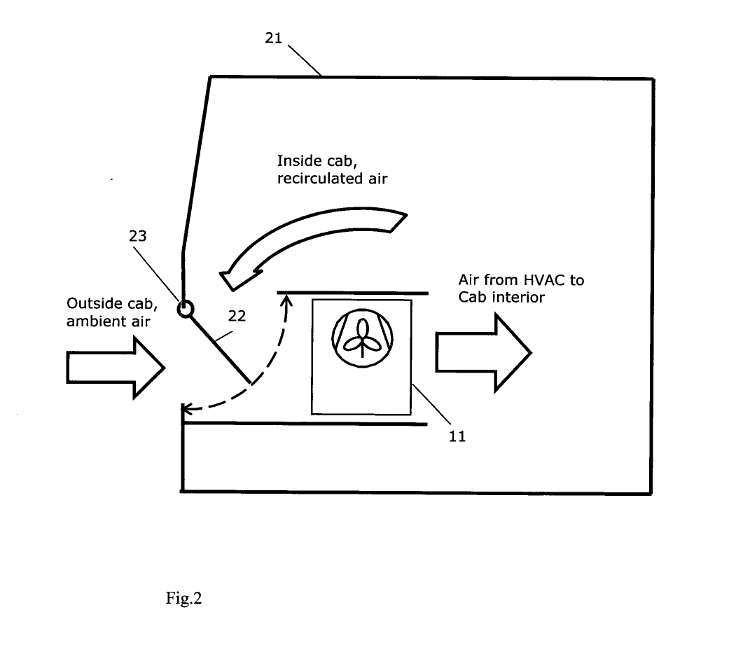

FIG. 2 illustrates the ventilation functionality of a truck cab 21 equipped with a HVAC system. A ventilation valve door 22 is pivotally hinged at 23 and is coupled to a not shown actuator which allows the valve door to move between fully closed and fully open positions. When the valve door 22 is fully open, ambient air can be drawn into the interior of the truck cab 21 by means of the evaporator 11 fan for ventilation. The door 22 will be fully closed when the HVAC system is operating to cool the interior of the truck cab 21.

Activation: Automatic climate regulator software in the climate control unit 18 can choose between a Parking-cooler mode, a Parking-heater mode or only Ventilation mode dependent on the ambient and interior temperature, and will control if and how much cooling power is needed. The activation of suitable mode (heating, cooling or ventilation) and the regulation is controlled through reading the cab interior temperature by means of the interior temperature sensor, and comparing with an operator set target temp at a climate control panel, and by reading the ambient temperature by means of the ambient temperature sensor.

In accordance with the invention, the above described HVAC system can be controlled by a timer function. This function enables an operator of the vehicle to set a target time, for example in the morning, when the vehicle shall be ready for use, and also to set a target temperature at which the vehicle interior is suitably conditioned for use, The software of the control unit decides if the interior of the vehicle should be cooled, heated or just ventilated in order for the HVAC system to provide the interior target temperature at the target time. The software will automatically control battery state of charge and regulate ventilation, cooling output and fan speed to reach the requested temperature without wasting energy.

When a vehicle, for example a commercial long haul truck, has been parked for driver rest/sleep, the driver of the vehicle can program the climate control unit 18 by entering a target time and a target temperature on a climate control panel, so that the interior air of the vehicle will be comfortable when the driver starts the next work shift. In accordance with the invention, the climate control unit 18 will initiate the conditioning procedure at a point of time before the set target time, for example 50 minutes before the set target time. First the control unit compares the target temperature with the ambient air temperature and the present interior air temperature.

Normally the interior air temperature of a vehicle is much higher than the ambient air temperature due to sun exposure. If the target temperature is lower than the interior air temperature, and the ambient air temperature is lower than the interior air temperature, a first phase of operation starts with ventilation of the interior with ambient air. When an interior temperature close to the ambient temperature is reached, for example at a point of time about 20 minutes after the start of the conditioning procedure, the AC-compressor 16 and condenser fan 17 are activated, and the ambient air intake is closed, shifting over to a recirculation cooling mode at maximum performance for a final phase of operation.

This will lower the temperature of the interior air further, if battery power allows, down to the set target temperature on the climate control panel. This phase continues for the remaining time until the target time set by the operator/driver is reached, i.e. for about 30 minutes. A battery sensor monitors the battery state of charge so that operation of the HVAC system can be shut down at a certain level.

By using, ambient air to condition the interior of the vehicle during a first phase of operation before the cooling phase, power consumption is considerably reduced.

The climate control unit 18 can be provided with additional process functionality. For example, a “Normal night cooling” function can be used for controlling the HVAC system when the vehicle has been parked after a driving shift. This control function can permit a higher cooling performance for the first 1-2 hours of operation when the truck engine is hot. When the truck has cooled down and during falling ambient temperature, the system will regulate down the performance in order to maximise the operation time relative to the available battery power.

A “Short stop” function may be used for shorter daytime stops (for example the lunch break) where it is possible to maximise the cooling power during a limited time without risking discharging the batteries. In theory the cooling performance can be maximized in order to maintain the (already conditioned) cab temperature at comfort level. Activation of this operation can be made by selecting a maximal low temperature setting on the climate control panel.

The invention is not to be regarded as being limited to the embodiments described above, a number of additional variants and modifications being possible within the scope of the subsequent claims. For example, the HVAC system has been described in relation with a commercial long haul truck vehicle but the invention is not limited to this use. Other examples of use can be recreational vehicles and pleasure boats.

1. A method of operating a vehicle heating, ventilating and cooling air conditioning system, the vehicle having an engine, to provide engine on and engine off operation, and a control unit (18) for timer controlled activation and temperature control of the air conditioning system when the engine is off, wherein the control unit (18) allows an operator to set a target time and a target temperature related to said target time, characterized in the step of:
ventilating an interior compartment of the vehicle to ambient air for a period of time before the set target time, if the target temperature is lower than the interior temperature and the ambient air temperature is lower than the interior temperature.

2. A method according to claim 1, characterized in the step of ending said ambient air ventilating period when the interior temperature is close to the ambient air temperature.

3. A method according to claim 2, characterized in the step of activating the air conditioning system cooling function for a period of time only if the ventilating period has ended before the target time and the interior temperature is above the target temperature.

4. A method according to claim 3, characterized in the step of deactivating the air conditioning system cooling function when the interior temperature is close to the target temperature.

5. A method according to any one of claims 1-4, characterized in the step of allowing the control unit (18) to automatically select a mode of operation for the HVAC system to minimize energy consumption.

6. A method according to claim 5, characterized in the step of only operating the air conditioning system cooling function until stored vehicle electric power capacity is consumed down to a certain level.

7. A vehicle comprising a heating, ventilating and cooling air conditioning HVAC system, the vehicle having an engine, to provide engine on and engine off operation, and a control unit (18) for timer controlled activation and temperature control of the air conditioning system when the engine is off, wherein the control unit (18) communicates with a sensor for interior compartment temperature and a sensor for ambient air temperature, and wherein the control unit (18) is adapted to control said air conditioning system according to any one of claims 1-5.

8. A vehicle according to claim 7, wherein the control unit (18) communicates with a capacity sensor for stored vehicle electric power and wherein the control unit is adapted to control said air conditioning system according to claim 6.

9. A vehicle according to claim 8, wherein the control unit (18) is provided with software for automatic control of battery state of charge and for regulating interior ventilation, cooling output and fan speed to reach a requested temperature with a minimum of electric energy waste.

10. A vehicle according to any one of claims 7-9, wherein the control unit (18) timer is integrated into the HVAC system.

11. A vehicle according to any one of claims 7 to 9, wherein an electrically driven condenser (12) cooling fan (17) of the HVAC system is adapted to supply cooling air to support an engine cooling fan when the vehicle engine is running.

12. A vehicle according to claim 10, wherein the control unit (18) is adapted to open an ambient air inlet regularly in order to avoid carbon dioxide build-up in the vehicle interior.
